(19) United States
(12) Patent Application Publication
(10) Pub. No.: US 2012/0050687 A1
(43) Pub. Date: Mar. 1, 2012

(54) CREATING A LIGHTING EFFECT

(76) Inventors: Elizabeth Berry, London (GB); Mark Hanna, London (GB)

(21) Appl. No.: 13/142,176

(22) PCT Filed: Dec. 24, 2009
(86) PCT No.: PCT/GB2009/051775

§ 371 Date: Nov. 14, 2011

Related U.S. Application Data
(60) Provisional application No. 61/140,817, filed on Dec. 24, 2008.

(51) Int. Cl. G03B 21/28

(52) U.S. Cl. 353/10; 353/121

(57) ABSTRACT

A method of creating a lighting effect using a reflective and semi-transparent foil suitable for use in creating a Pepper's Ghost image, the method comprising: i) modifying the foil such that the foil is distorted to cause light beams to separate into beams of different colours through transmition and reflection of the light beam in at least one sheet of foil; and ii) illuminating the distorted at least one sheet of foil to create a lighting effect.

### CROSS REFERENCE TO RELATED APPLICATION

This application claims priority to “CREATING A LIGHTING EFFECT,” having serial number PCT/GB2009/051775, filed on Dec. 24, 2009, which claims priority to and the benefit of U.S. Provisional Application No. 61/140,817, filing date 24 Dec. 2008, each of which is incorporated by reference herein.

### FIELD OF THE INVENTION

The present invention relates to a foil for creating lighting effects and in particular a reflective and semi-transparent foil for creating lighting effects.

### BACKGROUND OF THE INVENTION

Video production techniques are well known in the art and are commonly used for creating special effects in motion pictures in the form of Pepper's ghost images. Typically a real object or an image of a subject is reflected by a partially-reflective foil that also allows a background scene to show through. From the perspective of a viewer a foil is invisible and the reflected image appears as a transparent “ghost” superimposed over the background scene.

At its most simple, a single sheet of foil may be hung or suspended freely or in a frame in such a way as to be in the path of one or more lights. Being able to see the shape of a light beam as it passes through the plane of an almost invisible foil creates the impression of a 2 dimensional projection using a screen invisible to the viewing audience.

This may allow for high quality projection of light and images because the very thin nature of the highly reflective, semi transparent foil with a reflective coating of high optical quality will not create double reflections within the image such as when glass is used, and does not allow for the path of the light beam to be seen through the air such as when a light beam passes through smoke.

This characteristic is unique because it creates a high quality image, but does not readily identify the source of any light used to create an effect on the foil, so there is the possibility to obscure the source and mystify the observers. It furthermore removes the disadvantage experienced with traditional screens that when the screen is not needed for viewing images, either it must be somehow moved or removed (for example a roller screen may be deployed), or it requires a lighting effect or holding image to be placed upon it in order to avoid having an obvious blank surface visible to an audience.

There are also specialised lighting effect systems that can be arranged to provide colour and image changing lighting effects (e.g. colour-changing LED lighting systems or lighting systems with moving filters or the like). These systems generate coordinated lighting and image effects and are typically popular in theatre and television and are also becoming popular in other venues where colour changing lighting and image effects are desirable.

Creating lighting effects have generally been implemented using complicated machinery and designs which require a number of inputs from different devices. For example, when creating water effects on stage requires the use of an especially configured lighting device, such as a moving light with a water-effect template or gobo which must be positioned advantageously to place the image in the intended place, but the overall effect from a static or rotating gobo in such a device is generally more mechanical and does not produce a high quality projection.

Another type of lighting effect is the use of 3-dimensional objects, which can then be lit to create an effect. Various 3D geometric or non-geometric shapes, such as spheres, cubes and random shaped objects can be created using different techniques. One such 3D object is the mirror ball which is used in a number of different locations including night clubs and discos. Traditional mirror balls have many inherent problems that stem from the fact that due to the rotating nature of a mirror ball, it is often impossible to attach a safety cable to the mirrored sphere that would both allow smooth rotation of the ball, and prevent it falling in the event of structural failure of any part of the suspension equipment or rotation device. A safety wire attached to the ball with a freely moving rotating anchor point still tends to drag the ball and give the effect of the rotation slowing down and speeding up, especially when the device first starts to move. The weight of the mirror ball is such that this hazard is dangerous to anyone who might be standing under the ball when such failure occurred, and moreover the weight of the ball and the inertia exhibited by large mirror balls especially, tend to cause wear on the rotators and make operational or catastrophic failure more likely.

Another problem associated with traditional mirror balls is that it is difficult to create large diameter balls (for example over 2m diameter). It is difficult to rotate such a ball from a single central suspended rotator due to the weight and inertia exhibited by the ball.

Another problem associated with traditional mirror balls is that due to the expense and fragility of mirrored glass facets means that they are generally transported and stored in custom built travel cases that are fairly expensive and are of a size slightly larger than the mirror ball itself. This means that they occupy a lot of storage space when stored, whether full or empty, and a lot of truck space when transported.

Accordingly, it is desirable to develop a reflective and semi-transparent foil that can be easily used and modified to create different lighting effects.

### SUMMARY OF THE INVENTION

According to a first aspect, the present invention provides a method of creating a lighting effect using a reflective and semi-transparent foil suitable for use in creating a Pepper's Ghost image, the method comprising: i) modifying the foil such that the foil is distorted to cause light beams to separate into beams of different colours through transmition and reflection of the light beam in at least one sheet of foil; and ii) illuminating the distorted at least one sheet of foil to create a lighting effect.

According to a further aspect, the present invention provides a method of creating a lighting effect using a reflective and semi-transparent foil suitable for use in creating a Pepper's Ghost image, the method comprising: i) modifying the foil to provide a series of creases to form a corrugated shape in at least one sheet of foil; and ii) illuminating the creased at least one sheet of foil to create a ripple effect.

According to a still further aspect, the present invention provides a method of creating a lighting effect using a reflective and semi-transparent foil suitable for use in creating a Pepper's Ghost image, the method comprising: i) modifying the foil to form a closed 3-dimensional shape from the at least one sheet of the foil; and ii) illuminating the 3-dimensional shape to create a lighting effect.

The 3-dimensional shape may be a ball.

According to a still further aspect, the present invention provides a reflective and semi-transparent foil suitable for use in creating a Pepper's Ghost image, the foil comprising: an active element which when activated by any one or more of a temperature, an electric current, an electric field, a chemical process, a particular wavelength of light, a sound wave and a magnetic field creates a change in the reflection and transmission of light of the at least one sheet of foil.

The active element may comprise any one of the following: a UV activated die or paint applied to the foil; a layer of nano-particles applied to the foil comprising a phosphur based or a phosphur sensitive nano-particle.

The current invention has several advantages over the known prior art. The foil used in creating the lighting effect cannot shatter and poses no danger to crew installing it or working along side it. The foil can be installed into moving scenery without fear of it breaking as it is moved. This means that it is a very straightforward process to fly the system in and out of stages as required. Also the non-fragile nature of a foil shape used in place of a mirror ball allows for the possibility of the foil shape to be flattened or partially dismantled or compressed for travelling, and a smaller hard or soft casing may be deployed in order to offer a minimal protection from dirt and incidental mechanical damage. The foil used in the present invention to produce the number of various lighting effects is far less vulnerable to trauma and mechanical damage than an equivalent device using mirrors or glitter to create similar effects.

Finally the foil used to create lighting effects in accordance with the present invention may or may not be stressed or tensioned or angled or placed with regard to the audience and the light sources, and the foil may hang straight or be retained on more than one edge to create swags or twists other shapes which introduce more than one layer of foil into the light path. The foil may be used flat or crumpled or have another surface texture which may be used to create effects such as water.

The various features of novelty which characterise the present invention are pointed out with particularity in the claims annexed to and forming part of this disclosure. For a better understanding of the present invention, its operation, advantages and specific objects attained by its use, reference should be had to the accompanying drawings and descriptive matter in which preferred embodiments of the invention are illustrated and described.

### BRIEF DESCRIPTION OF THE DRAWINGS

FIG. 1 is a schematic of a foil according to an embodiment of the present invention when a creased foil is placed on a floor;

FIG. 2 is a schematic of a foil according to an embodiment of the present invention when the foil is roughly a spherical mass;

FIG. 3 is a schematic of a Pepper's Ghost illusion according to an embodiment of the present invention; and

FIG. 4 is a schematic of a foil according to an embodiment of the present invention when the foil contains nanoparticles which are capable of generating light.

### DESCRIPTION OF PREFERRED EMBODIMENT

To be effective in delivering a quality image, the image to be projected into the foil panel 10, 12, 22 and reflected should be projected as high definition (HD) video and if the projected image is to be a human figure, then the foil 10, 12, 22 should be capable of producing a life size image.

In order to produce the lighting effects of the present invention the transparent-reflective foil 10, 12, 22 is essentially the same as a beam splitter; however, no light beam is actually divided as the foil 10, 12, 22 can transmit and reflect light beams. Those in the optical coating art will understand the vast variations possible for the transparent-reflective foil 10, 12, 22 in regard to its substrate, coating, and manufactured process. Both plastic and glass substrate foils, as well as stretched mylar, have been successfully used for the transparent-reflective foil 10, 12, 22. The transparent-reflective foil 10, 12, 22 can range from a custom blend of optical coatings on a transparent substrate for superior reflectivity and transmissivity all the way down to off-the-shelf one-way mirrors with inconsistent and poor optical qualities. Also, the reflectivity and transmissivity, as well as other optical qualities of the transparent-reflective foil 10, 12, 22, can be adjusted as required.

The transparent-reflective foil 10, 12, 22 should have sufficient transparency to allow a camera to capture a quality image from the opposite side and to allow projected light to pass through without substantial reflection. The quality image is required for the Pepper's ghost illusion. The Pepper's ghost is an illusionary technique used in theatre and in some magic tricks. Using a plate glass or film 10, 12, 22 and special lighting techniques, it can make objects seem to appear or disappear, or make one object seem to “morph” into another. The transparent-reflective foil 10, 12, 22 must also be substantially reflective so that a quality image is reflected from the front projection screen.

Antireflective coatings can be applied as needed to suppress unwanted reflections from any of the optical surfaces involved. On the back side of the transparent-reflective foil 10, 12, 22, opposite the viewing side, an antireflection coating can serve to eliminate the ghosting effect apparent with many types of transparent-reflective panels. Despite the vast variations possible for the transparent-reflective foil 10, 12, 22, the property of being both reflective and transparent remains the single most important constant.

One known example for manufacturing a transparent-reflective foil 10, 12, 22 is to pressurise or depressurise a thin plastic membrane into a required shape. By using a multi-layer panel having a curved reflecting or transmitting facing layer is produced by blowing a thin plastic membrane held in a frame and then backed by a polyurethane layer supported by fibre glass to retain the shape of the thin membrane while being either pressurised or de-pressurised by a pressure chamber. Obviously there are other methods which can be used to produce the foil 10, 12, 22 without departing from the scope of the invention, the present method is used to provide an example of one such method.

The following paragraphs show some examples of uses of the foil 10, 12, 22. This section outlines several ways that the foil 10, 12, 22 can be used and rigged for different advantageous effects. The different deployments allow the foil 10, 12, 22 to offer alternatives to various other available technologies and devices which would not normally offer benefits in all of the areas discussed.

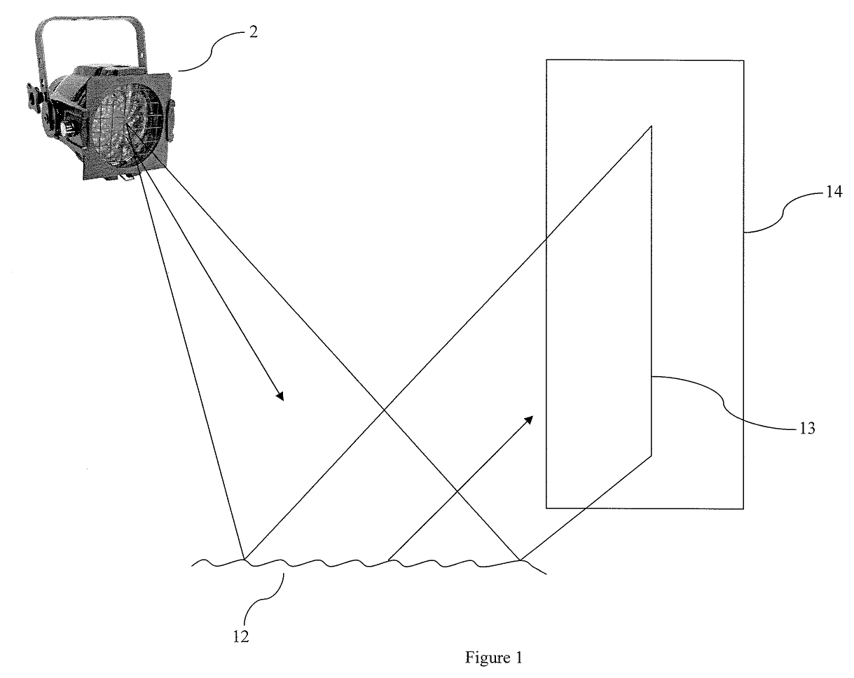

As shown in FIGS. 1 to 4 a highly reflective and semi transparent foil 10, 12, 22 may be rigged or suspended in panels or sheets or pieces or fragments with or without the use of a frame or tensioning devices. At its most simple, a single sheet of foil 10, 12, 22 may be hung or suspended freely or in a frame in such a way as to be in the path of one or more lights. FIGS. 1 to 4 show a sheets of foil 10, 12, 22 which may be suspended from a roof, lit with a light source 2 along light path 3 such that the light emitting from the fixture hits the sheet of foil creating an image 4. Part of the light is transmitted through the foil onto another surface 5 along light path 6 creating a further, enlarged image 8, and part of the light is reflected off the front of the foil along light path 7.

Being able to see the shape of a light beam 2 as it passes through the plane of an almost invisible foil 10, 12, 22 creates the impression of a 2 dimensional projection using a screen invisible to the viewing audience. This allows for high quality projection of light and images because the very thin nature of the highly reflective, semi transparent foil 10, 12, 22 with a reflective coating of high optical quality will not create double reflections within the image such as when glass is used, and does not allow for the path of the light beam to be seen through the air such as when a light beam passes through smoke.

This characteristic is unique because it creates a high quality image, but does not readily identify the source of any light used to create an effect on the foil 10, 12, 22, so there is the possibility to obscure the source and mystify the observers. It furthermore removes the disadvantage experienced with traditional screens that when the screen is not needed for viewing images, either it must be somehow moved or removed (for example a roller screen may be deployed), or it requires a lighting effect or holding image to be placed upon it in order to avoid having an obvious blank surface visible to an audience.

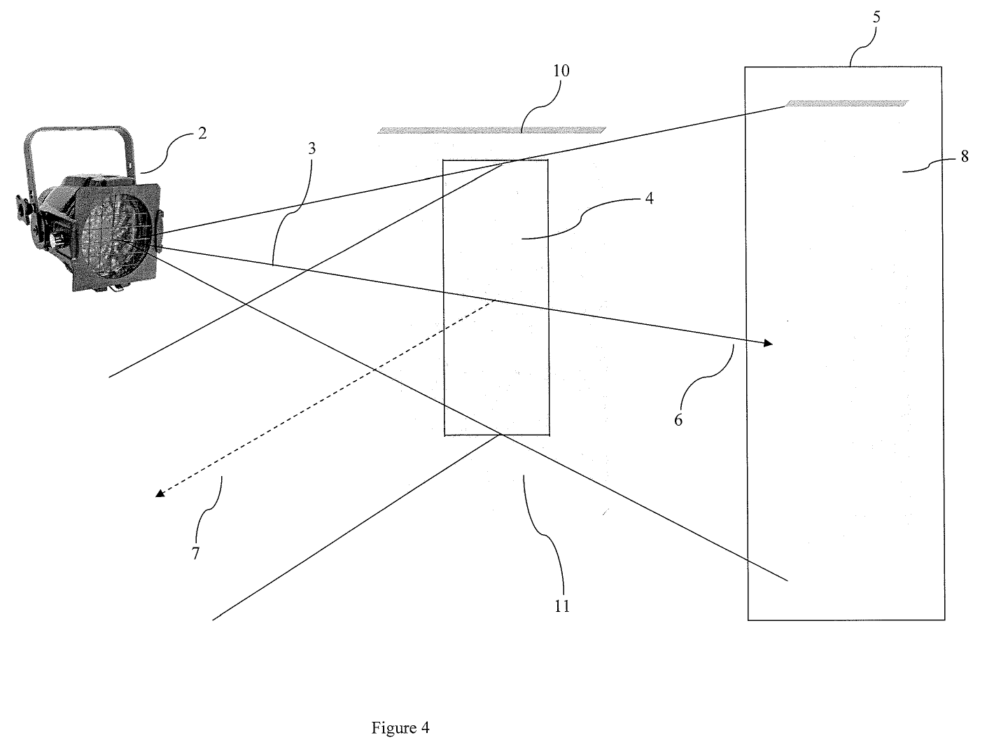

In one example, the foil 10, 12, 22 may be held at any angle between 0 and 90 degrees with respect to a mounting device which can be located on or near the ceiling of a studio, or preferably at 45 degrees to the mounting device in a frame with tensioning devices employed to smooth out the surface of the foil 10, 12, 22. A ‘Pepper's Ghost’ effect or illusion may be created, allowing a reflection of the light beams to appear behind the foil 10, 12, 22. This is further described below and shown in FIG. 4.

Further effects may be created by the light being projected from different angles and being transmitted, reflected and refracted by the foil 10, 12, 22 or a coating applied on one or both sides of the foil 10, 12, 22 or by an active element held within the foil 10, 12, 22. This may cause the creation of light beams of a colour other than the original source part of the beam due to a prismatic effect on the incident light, and the component wavelengths being separated out in the manner of white light hitting a prism in such a way as a rainbow may be observed in the light coming out of the prism. This can also be created by distorting the foil 10, 12, 22 to cause the light beams to separate into beams of different colours.

FIG. 1 shows a possible position of a light source 2 rigged above and in front of a strip of creased foil 12 placed on the floor in order to create a ripple effect image 13 on a screen 14 placed behind the foil 12. The foil is modified by creasing the foil 12 or creating a series of creases in the foil 12 to form a corrugated shape in the foil 12. These corrugations can be formed in any shape including half circles, triangular shapes or u-shaped shapes. Any shape can be used dependent upon the type and shape of the ripple required. Here the semi-transparent, highly reflective foil 12 with surface texture alterations, and using multiple layers or sheets of this foil 12 are used to produce a ripple effect image like the rolling waves of an ocean. More complicated set-ups allow for the creation of different effects as the light passes through non-flat foil 12 and/or more than one layer of foil 12. These layers may be part of the same piece of foil 12.

In one embodiment, the rigging of the reflective and semi transparent foil 12 may be placed under tension in such a way as to deliberately introduce ripples or irregularities in the surface such as one might expect if tensioning was uneven or various regular or irregular shapes of foil 12 were used. The foil 12 may alternatively be allowed to hang freely, suspended by one or more sides or edges or corners or extremities or by being attached by any other part of the foil 12, such as the centre, allowing the edges to hang free.

The foil 12 may be used as a single level or layer or sheet, or many layers or levels or sheets, and each one of these pieces may be suspended or rigged in any of the ways described and at the same or different angles to each other and either separately or in a group.

The foil 12 may be laid on the floor, or over or around an object, or hung over a wire or any similar device, or attached to an object or surface, or retained in some kind of frame or support. Light may be bounced off it or through it, with or without the use of a projection screen or other external reflective surface to bounce light back through or at the foil or other surface or further foil 12 installations. The foil 12 may be flat and smooth or have irregularities on the surface to refract incident light, such as creases, folds, cuts, laser marks, etchings or diffusive coatings. Other materials such as fabrics, lighting gel or paint effects may be applied to the surface of the foil 12 to create different visual effects. These effects may be seen in a change to the light beam passing through or being reflected off the surface of the foil and/or the characteristic of the viewed surface of the foil 12 as the light beam passes through the foil 12 itself.

The foil 12 may be stressed or tensioned or angled or placed with regard to the audience and the light sources, and the foil 12 may hang straight or be retained on more than one edge to create swags or twists and other shapes which introduce more than one layer of foil 12 into the light path. The foil 12 may be used flat or crumpled or have another surface texture which may be used to create effects such as water.

The highly reflective nature of the foil 12 and the transparent qualities of the foil 12 allow it to be deployed and remain unseen by a viewing audience until such time as the light is placed on the foil 12 to create the lighting effect. The difficulty of incorporating the physicality of alternative devices commonly used to create these effects is frequently problematic on stage and in similar situations.

One example might be to create a ripple effect on a screen at the back of a stage by bouncing blue light off a strip of crumpled or creased foil 12 on the floor. Using a traditional flexible mirror-coated foil 12 in a strip across a stage in a position that is necessary to create this water effect also requires that the sight of the mirror-coated foil 12 is not otherwise objectionable on the stage. The advantage of a near-invisible transparent foil 12 to create the effect is that there is not the presence of a grey strip across the stage.

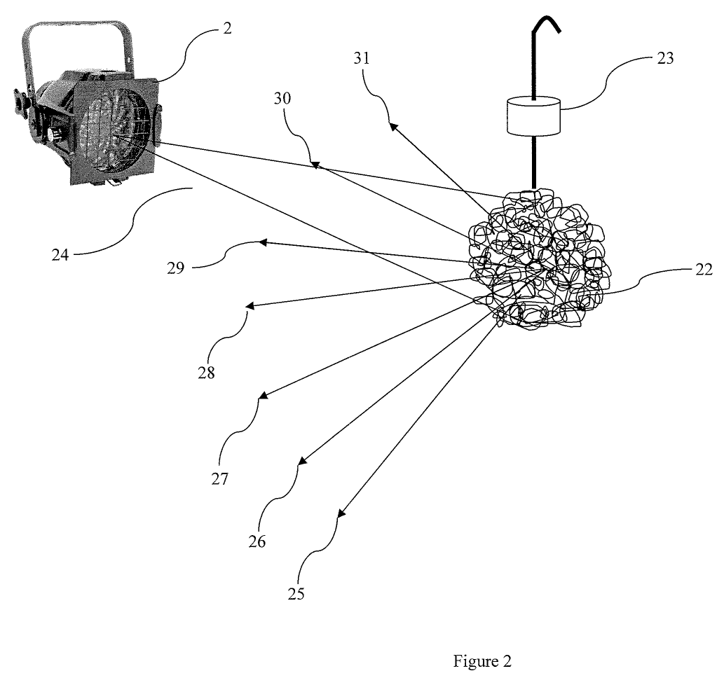

FIG. 2 shows a possible configuration of a light source 2 used to illuminate of a roughly spherical or ball shaped mass of foil 22 suspended from a rotation device 23. The light from the light source 2 travels along light paths 24 and is scattered when it hits the foil 22, symbolised by multidirectional arrows 25 to 31.

The foil 22 can be used to create solid masses of foil 22 in various 3D shapes, such as spheres, cubes and random shaped objects created using techniques such as putting an amount of crumpled foil 22 in a net or bag. These can then be lit by a light source 2, and the light will bounce off the surfaces of the foil 22 in many ways and directions creating multiple-light beam effects such as has been previously been created using mirror balls or glittery surfaces in the path of projected light.

This embodiment offers the improvement over traditional mirror balls that by the rotating nature of a mirror ball, it is almost impossible to attach a safety cable to the mirrored sphere or ball that would both allow smooth rotation of the ball, and prevent it falling in the event of structural failure of any part of the suspension equipment or rotation device. A safety wire attached to the ball with a freely moving rotating anchor point still tends to drag the ball and give the effect of the rotation slowing down and speeding up, especially when the device first starts to move. The weight of the mirror ball is such that this hazard is dangerous to anyone who might be standing under the ball when such failure occurred, and moreover the weight of the ball and the inertia exhibited by large mirror balls especially, tend to cause wear on the rotators and make operational or catastrophic failure more likely.

It is possible to attach a safety wire to a rotating foil sphere 22 or other shape, however, the lightness of the material means that there is very little danger to anyone on whom the foil 22 construction may fall, and moreover that the wear in the rotator is substantially reduced. A further benefit of this invention is that current mirror balls of large diameter (for example 2m or over) are difficult to rotate from a single central suspended rotator due to the weight and inertia exhibited by the ball. A more lightweight solution allows for much larger creations to be successfully rotated, and furthermore allows the use of much longer suspension cables, wires or similar as the reduced inertia diminishes the tendency for the suspension cable etc to twist itself up before any rotation is transferred to the suspended object.

The expense and fragility of mirrored glass facets on traditional mirror balls means that they are generally transported and stored in custom built travel cases that are fairly expensive and are of a size slightly larger than the mirror ball itself. This means that they occupy a lot of storage space when stored, whether full or empty, and a lot of truck space when transported. The non-fragile nature of a foil 22 shape used in place of a mirror ball allows for the possibility of the foil 22 shape to be flattened or partially dismantled or compressed for travelling, and a smaller hard or soft casing may be deployed in order to offer a minimal protection from dirt and incidental mechanical damage. The foil 22 construction itself is far less vulnerable to trauma and mechanical damage than an equivalent device using mirrors or glitter to create a similar effect.

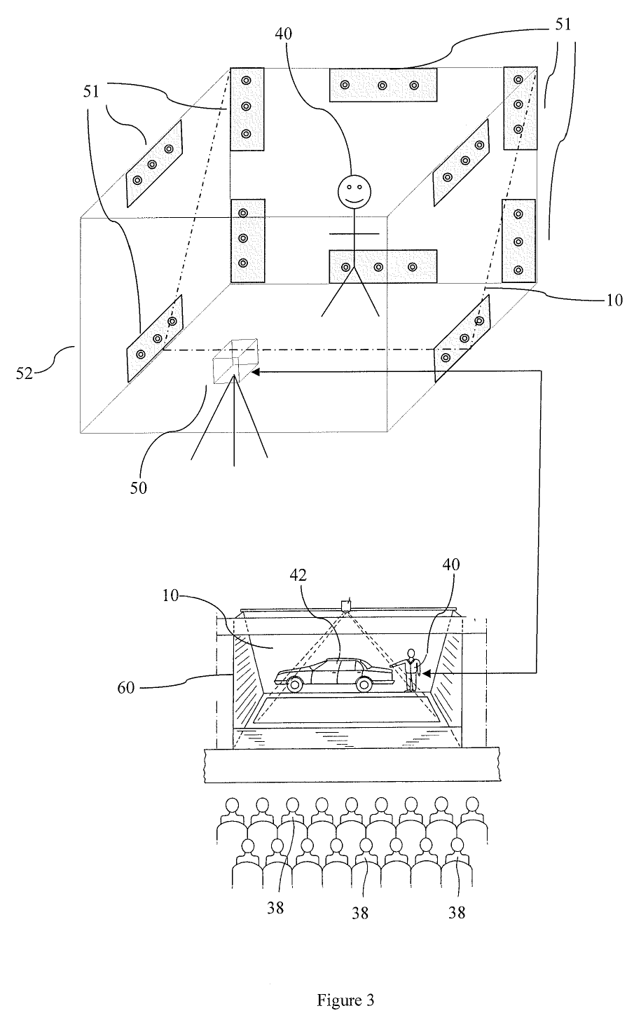

FIG. 3 shows the use of a foil 10 used to produce the Pepper's ghost illusion. In this example a studio 52 is located remotely from a stage or theatre 60. The studio 52 comprises a stage area or platform or a riser forming a stage platform on which the subjects 40 or performers are placed for greater visibility. For example a stage platform (riser) 47 approximately 1′ high extends across the width of the studio 52 (generally 9′ if arranged at one end of the trailer, or 20 ft-30 feet wide if arranged lengthways across the trailer). Preferably steel deck stage or similar material gives the subject 40 a spatial boundary to work within and should match the dimensions of the show or theatre stage 60 or the camera 50 lens frame area, whichever is smaller. The camera 50 lens frame limits should be explained to the filmed subject 40 and markers set for him to see, though not visible to the camera 50 lens. Although the height of the studio 52 need not be the same as the show stage 60, the difference is an essential figure in calculating the height of the camera 50. The stage platform also avoids having to set the camera 50 on the studio floor to achieve the correct height.

The studio 52 is used to produce video and audio performances wherein the studio 52 may allow a real time communication of a two-way interaction between two or more subjects 40 located remotely of one another. In order for the Pepper's ghost illusion to work, the viewer or audience 38 must be able to see into the main room or theatre 60, but not into the hidden mirror room or studio 52. The edge of the foil 10 may be hidden by a cleverly designed pattern in the floor. In this case the two rooms are located remotely from one another. The studio 52 is located remotely from the theatre or stage 60. Both rooms may be identical mirror-images; this approach is useful in making objects seem to appear or disappear, however it is not required that both rooms are identical if the room or studio 52 in which the subject 40 is completely black inside so as to not include anything other than the subject 40 in the captured image. This effect can also be used to make an actor reflected in the foil 10 appear to turn into an actor behind the foil 10 (or vice versa). This is the principle behind the Girl-to-Gorilla trick found in many haunted houses. The mirror room may instead be painted black (as in this case with the studio 52), with only light-coloured objects in it. When light from light sources 51 is cast on the objects 40, they reflect strongly in the foil 10, making them appear as ghostly images 40 superimposed in the visible room or theatre 60.

The lighting of the filming subject 40 may be of any type suitable for providing sufficient illumination for a high definition (HD) image capture. A number of lighting assemblies 51 are located in the studio 52 suitable for presenting an environment of immersive ambience to the audience 38 in a viewing venue or theatre 60 thus producing a compelling mixture of colour and contrast on stage and correctly illuminated live talent on stage and audiences for sharp, realistic signal feeds and audience signal feeds.

In FIG. 3 a presenter or subject 40 resides behind an inclined, reflective and semi-transparent foil 10 onto which an image of, for example, a motor vehicle 42 is projected. The location of the subject or presenter 40 behind the projected image has a number of inherent advantages over systems where the presenter 40 stands in front of a screen, not least of which is that the presenter 40 does not obscure the projected image when walking across the projected image. Additionally, the use of an inclined foil 10 results in a viewer or audience 38 of the image perceiving the image as having depth rather than merely being a two dimensional image, for example where a motor vehicle 42 is seen to rotate upon a turntable. The projection of an image upon a partially reflective foil 10 such that is observable by a viewer 38 positioned in front of the screen is known as the “Peppers ghost” illusion.

In a further example the foil may include an active element which when activated by temperature, an electric current, an electric field, a chemical process, a particular wavelength of light and preferably a UV light, a sound wave or waves or a magnetic field can create a change in the reflection or transmission of light through the foil. The active element allows an image to appear when the foil is lit either with normal light or light of a particular characteristic such as Ultra Violet light or when a light from a different angle to another light source is introduced. This processing may be visible to the naked eye when the foil is otherwise viewed. The processing may be a coating or a chemical or another process designed to create an effect such as pictures, moving images, starburst effects or polarising. It may be caused by heat or water or other liquids being applied to the surface of the foil post manufacture. It may be that passing of an electrical current or a control signal through the foil which can be used to directly or indirectly activate or create an effect or change in the optical qualities of the foil, when acted upon by transmitted or reflected light.

In a further example the processing of the foil with a UV activated dye or paint can be used to create a company logo upon the surface of the foil. The UV activated die or paint is initially invisible but becomes visible when a UV light is introduced and the activated die or paint emits a glow, revealing the company logo.

A further example of this might involve the foil 10 being activated by either an electrical or some other control signal that subsequently activates white or coloured light to be emitted from the foil 10 at one or various intensities. In this further example the foil 10 may be controlled by a remote device (not shown) in order to create images or effects, such as television pictures or static images or colours or shapes. FIG. 4 shows an example of this activation using sub-miniature nanoparticles 11 or devices which are capable of generating light.

This example may include the use of the foil 10 as a semi-transparent medium to carry nanoparticles 11 that may be phospur-based or phospur-sensitive, and capable of responding to an applied or directed energy source which may include stimulation by electricity or light. FIG. 4 shows a sheet of foil 10 with nanoparticles 11, the foil 10 is suspended from a roof and lit with a light source 2 along light path 3 such that the light emitting from the fixture hits the sheet of foil 10 activating the nanoparticles 11 within the image 4. The nanoparticles 11 produce light and this light is transmitted through the foil 10 onto another surface 5 along light path 6 creating a further, enlarged image 8, and part of the light is reflected off the front of the foil 10 along light path 7.

A variation of this example might be that the activator for the emission is the presence on the relevant part of the foil 10 of a light source 2 which stimulates the emission of further light from the particles therein. The advantages of an almost invisible, robust, lightweight, light generating device which is capable of creating intelligible moving or still images includes the lightness, the portability, the flexibility the unobtrusiveness and the low power consumption that such a device can produce.

By way of a final example, the foil may be used in conjunction with external manipulation devices to create further effects. Additional movement may be introduced by the use of mechanical, natural or human interaction such as blowing fans at the foil, or by positioning the foil in areas of natural air movement, or by allowing people to physically move the foil to generate further effects. An example of this may be the use of blowing fans on a crumpled foil under blue light to give the effect of rippling water.

Although the present invention has been illustrated and described with respect to exemplary embodiment thereof, it should be understood by those skilled in the art that the foregoing and various other changes, omission and additions may be made therein and thereto, without departing from the scope of the invention. Therefore the present invention should not be understood as limited to the specific embodiment set out above but to include all possible embodiments which can be embodied within a scope encompassed and equivalent thereof with respect to the features set out in the appended claims.

1. A method of creating a lighting effect using a reflective and semi-transparent foil suitable for use in creating a Pepper's Ghost image, the method comprising:
i) modifying the foil such that the foil is distorted to cause light beams to separate into beams of different colours through transmition and reflection of the light beam in at least one sheet of foil; and
ii) illuminating the distorted at least one sheet of foil to create a lighting effect.

2. A modified foil for creating a lighting effect in accordance with step i) of claim 1.

3. A method of creating a lighting effect using a reflective and semi-transparent foil suitable for use in creating a Pepper's Ghost image, the method comprising:
i) modifying the foil to provide a series of creases to form a corrugated shape in at least one sheet of foil; and
ii) illuminating the creased at least one sheet of foil to create a ripple effect.

4. A modified foil for creating a lighting effect in accordance with step i) of claim 3.

5. A method of creating a lighting effect using a reflective and semi-transparent foil suitable for use in creating a Pepper's Ghost image, the method comprising:
i) modifying the foil to form a closed 3-dimensional shape from the at least one sheet of the foil; and
ii) illuminating the 3-dimensional shape to create a lighting effect.

6. The method according to claim 5, wherein the 3-dimensional shape is a ball.

7. A modified foil for creating a lighting effect in accordance with step i) of claim 5.

8. A reflective and semi-transparent foil suitable for use in creating a Pepper's Ghost image, the foil comprising:
an active element which when activated by any one or more of a temperature, an electric current, an electric field, a chemical process, a particular wavelength of light, a sound wave and a magnetic field creates a change in the reflection and transmission of light of the at least one sheet of foil.

9. The foil according to claim 8, wherein the active element comprises any one of the following:
a UV activated die or paint applied to the foil; and
a layer of nano-particles applied to the foil comprising a phosphur based or a phosphur sensitive nano-particle.
